(19) United States
(12) Patent Application Publication
(10) Pub. No.: US 2023/0294321 A1
(43) Pub. Date: Sep. 21, 2023

(54) Saw Stop and Measurement Systems and Related Methods

(71) Applicant: Integrity LLC, South Jordan, UT (US)

(72) Inventor: Larry Cluff, South Jordan, UT (US)

(73) Assignee: Integrity LLC, South Jordan, UT (US)

(21) Appl. No.: 18/182,265

(22) Filed: Mar. 10, 2023

Related U.S. Application Data
(60) Provisional application No. 63/321,806, filed on Mar. 21, 2022.

(51) Int. Cl. B27B 27/02; B23Q 16/00

(52) U.S. Cl. CPC B27B 27/02; B23Q 16/001

(57) ABSTRACT

Saw stop systems may include a first housing couplable with a saw, a control module coupled with the first housing and including a processor (the control module configured to communicatively couple with a computing device having a user interface) and one or more trackways coupled with the first housing. A sliding member is slidably coupled at least partially within the one or more trackways. A first portion of the one or more trackways prevents bending of the sliding member within the first portion. A stop coupled with the sliding member couples with an end of an item to be cut to facilitate positioning of the end of the item, relative to a cutting element of the saw, at a determined distance corresponding with a length received through the at least one user interface. A motor automatically positions the sliding member so that the stop is at the determined distance.

### CROSS REFERENCE TO RELATED APPLICATIONS

This document claims the benefit of the filing date of U.S. Provisional Patent Application No. 63/321,806, entitled “saw stop system,” naming as first inventor Larry Cluff, which was filed on Mar. 21, 2022, the disclosure of which is hereby incorporated entirely herein by reference.

### BACKGROUND

### 1. Technical Field

Aspects of this document relate generally to saw stop systems and methods and linear slide systems and methods.

### 2. Background Art

U.S. Pat. No. 5,426,863 to Biggel discloses a combined tape measure and calculator that optically detects equally-spaced holes along the length of its tape. The holes are read by a number of closely spaced optical readers arranged to generate incremental unit signals for a microprocessor mounted in a case of the tape measure. U.S. Pat. No. 5,875,987 to Pullen discloses a motorized tape measure. U.S. Pat. No. 8,555,762 to Jones, et al. discloses a saw stop assembly with a fence and a stop. The fence and stop have opposing teeth to engage together. U.S. Pat. No. 8,783,140 to Dick, et al. discloses a gauge system for workpiece processing. U.S. Pat. No. 9,774,986 to Hoge discloses a Bluetooth-enabled measuring system and discloses associating received measurements with user-input characteristics. U.S. Pat. No. 9,943,975 to Dick, et al. discloses a saw system for miter joints including a calibration method. U.S. Pat. No 10,859,363 to Murray, et al. discloses an electronic tape reading assembly using an optical encoder. U.S. Pat. No. 11,554,513 to Larsson discloses a fence apparatus and an adjustable flip stop.

### SUMMARY

Saw stop systems disclosed herein may be portable or stationary and may be used for or with (or may include) any miter box or other system/element that may benefit from an electro-mechanical linear trackway. The saw stop systems can be used with or without a saw stand. Saw stop systems disclosed herein may include a new type of slide along a non-linear, non-sequential trackway.

In some aspects, the techniques described herein relate to a saw stop system, including: a first housing configured to be coupled with a saw; a control module coupled with the first housing and including a processor, the control module configured to communicatively couple with a computing device having at least one user interface; one or more trackways coupled with the first housing; a sliding member slidably coupled at least partially within the one or more trackways, wherein a first portion of the one or more trackways prevents bending of the sliding member within the first portion (in implementations it also prevents movement of the sliding member in at least one direction within the first portion); a stop coupled with the sliding member and configured to couple with an end of an item to be cut to facilitate positioning of the end of the item, relative to a cutting element of the saw, at a determined distance corresponding with a length received through the at least one user interface; and a motor coupled with the sliding member and controlled by the control module, the motor configured to automatically position the sliding member so that the stop is at the determined distance.

In some aspects, the techniques described herein relate to a saw stop system, further including a storage member coupled with the first housing and configured to force a stored portion of the sliding member into a coiled configuration.

In some aspects, the techniques described herein relate to a saw stop system, wherein the storage member includes a second housing at least partially housed within the first housing.

In some aspects, the techniques described herein relate to a saw stop system, wherein an extended portion of the sliding member includes a curvature transverse to a longest length of the extended portion.

In some aspects, the techniques described herein relate to a saw stop system, wherein the one or more trackways at least partially encases two edges of the extended portion of the sliding member.

In some aspects, the techniques described herein relate to a saw stop system, further including an extender configured to couple between the item and the stop, and wherein the determined distance includes the received length added to a length of the extender.

In some aspects, the techniques described herein relate to a saw stop system, wherein a second portion of the one or more trackways bends the sliding member within the second portion.

In some aspects, the techniques described herein relate to a saw stop system, wherein the one or more trackways include multiple trackways coupled together.

In some aspects, the techniques described herein relate to a saw stop system, further including a drive wheel coupled with the motor and configured to rotate in response to a rotation of the motor, the drive wheel contacting a first face of the sliding member, and a pinch wheel contacting a second face of the sliding member, wherein the drive wheel and the pinch wheel are biased toward one another.

In some aspects, the techniques described herein relate to a saw stop system, wherein the sliding member includes one or more length indicators, wherein the control module includes one or more visual sensors configured to sense the one or more length indicators, and wherein the control module controls the motor to position the stop at the determined distance using the sensed one or more length indicators.

In some aspects, the techniques described herein relate to a saw stop system, wherein the one or more length indicators include tick marks and numbers, and wherein the control module controls the motor to position the stop at the determined distance using the tick marks and the numbers.

In some aspects, the techniques described herein relate to a saw stop system, wherein the control module further controls the motor to position the stop at the determined distance using a determined position interpolated between two of the tick marks.

In some aspects, the techniques described herein relate to a saw stop system, wherein the sliding member is configured to slide beyond a terminal end of one of the one or more trackways such that the stop is positioned beyond, and not partially within, the trackway.

In some aspects, the techniques described herein relate to a saw stop system, further including a guide coupled with the one or more trackways, the guide configured to support the item to prevent drooping of the item.

In some aspects, the techniques described herein relate to a saw stop system, further including a stand coupling the first housing with the saw, the stand configured to allow adjustment of the housing to multiple fixed positions relative to the saw along three axes, each of the axes orthogonal to the other two axes.

In some aspects, the techniques described herein relate to a method of use of a saw stop system, including: coupling a first housing of a saw stop system with a saw, wherein the saw stop system includes: a control module coupled with the first housing and including a processor, the control module configured to communicatively couple with a computing device having at least one user interface; one or more trackways coupled with the first housing; a sliding member slidably coupled at least partially within the one or more trackways, wherein a first portion of the one or more trackways prevents bending of the sliding member within the first portion (in implementations it also prevents movement of the sliding member in at least one direction within the first portion); a stop coupled with the sliding member; and a motor coupled with the sliding member and controlled by the control module; using the motor, automatically positioning the sliding member so that the stop is at a determined distance relative to a cutting element of the saw, wherein the determined distance corresponds with a length received through the at least one user interface; and coupling, to the stop, an end of an item to be cut.

In some aspects, the techniques described herein relate to a method, wherein a second portion of the one or more trackways bends the sliding member within the second portion.

In some aspects, the techniques described herein relate to a measurement system, including: a first housing; a control module coupled with the first housing and including a processor, the control module configured to communicatively couple with a computing device having at least one user interface; one or more trackways coupled with the first housing; a sliding member slidably coupled at least partially within the one or more trackways, wherein a first portion of the one or more trackways prevents bending of the sliding member within the first portion (in implementations it also prevents movement of the sliding member in at least one direction within the first portion); a stop coupled with the sliding member and configured to couple with an end of a first item to facilitate positioning of an end of the first item, relative to a second item, at a determined distance corresponding with a length received through the at least one user interface; and a motor coupled with the sliding member and controlled by the control module, the motor configured to automatically position the sliding member so that the stop is at the determined distance.

In some aspects, the techniques described herein relate to a measurement system, further including a storage member coupled with the first housing and configured to force a stored portion of the sliding member into a coiled configuration.

In some aspects, the techniques described herein relate to a measurement system, wherein a second portion of the one or more trackways bends the sliding member within the second portion.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a box diagram representatively illustrating elements of a saw stop system;

FIG. 2A is a side cross-section view of example components of a saw stop system;

FIG. 2B is a front, top, side view of the example components of FIG. 2A;

FIG. 2C is a back view of the example components of FIG. 2A;

FIG. 2D is a front, top, side view of example components of a saw stop system;

FIG. 3 is a top partial see-through view of example components of a saw stop system;

FIG. 4A is a top view of example components of a saw stop system;

FIG. 4B is a side view of the example components of FIG. 4A;

FIG. 5A is top view of example components of a saw stop system;

FIG. 5B is a front view of the example components of FIG. 5A;

FIG. 6 is a front view of a prior art miter saw and saw stand;

FIG. 7 is a front view of example components of a saw stop system coupled with a saw stand adjacent to a miter saw and an item to be cut;

FIG. 8 is a front view of some of the elements of FIG. 7 with additional example saw stop system components added;

FIG. 9 is a front view of some of the elements of FIG. 7 with additional example saw stop system components added;

FIG. 10A is a top view of a saw stop system;

FIG. 10B is a side view of the saw stop system of FIG. 10A;

FIG. 11 is a front view of example components of a saw stop system coupled with a saw stand adjacent to a miter saw;

FIG. 12 is a front, side, top view of some of the elements of FIG. 8 with additional example miter saw components shown;

FIG. 13 is a side view of a saw stand coupler and related elements;

FIG. 14 is a front view of a saw stand coupler and related elements; and

FIG. 15 is a top view of a saw stand coupler and related elements.

### DESCRIPTION

Implementations/embodiments disclosed herein (including those not expressly discussed in detail) are not limited to the particular components or procedures described herein. Additional or alternative components, assembly procedures, and/or methods of use consistent with the intended saw stop and measurement systems and related methods may be utilized in any implementation. This may include any materials, components, sub-components, methods, sub-methods, steps, and so forth.

Each prior art patent publication and issued patent, whose publication number or patent number is provided in this document, whether in the above background section or elsewhere, is incorporated herein entirely by reference, and saw stop and measurement systems and related methods disclosed herein may incorporate any elements and/or methods disclosed in those documents/references.

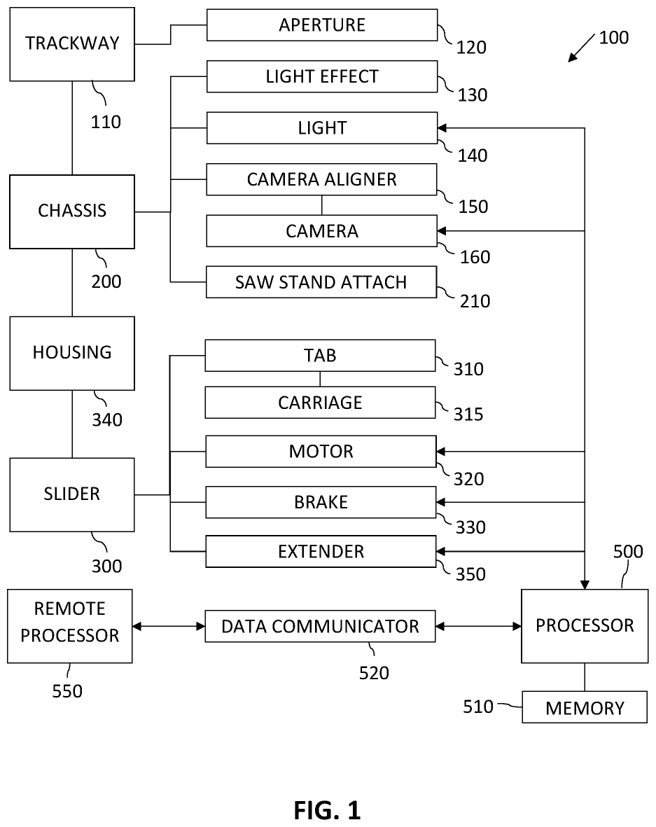

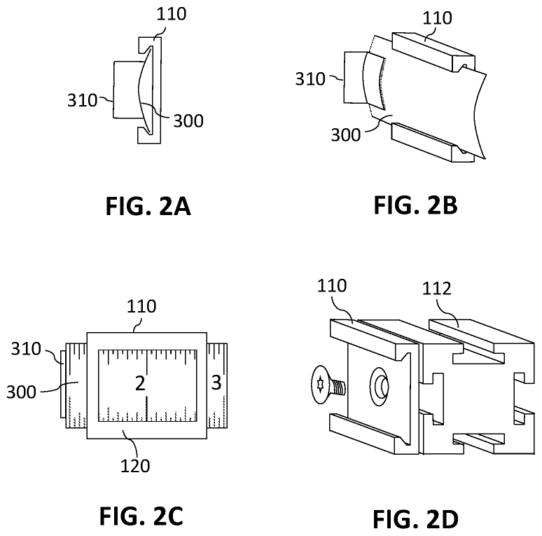

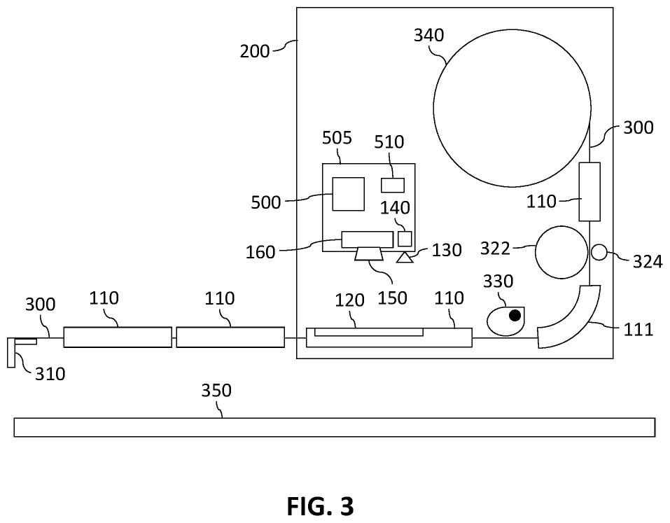

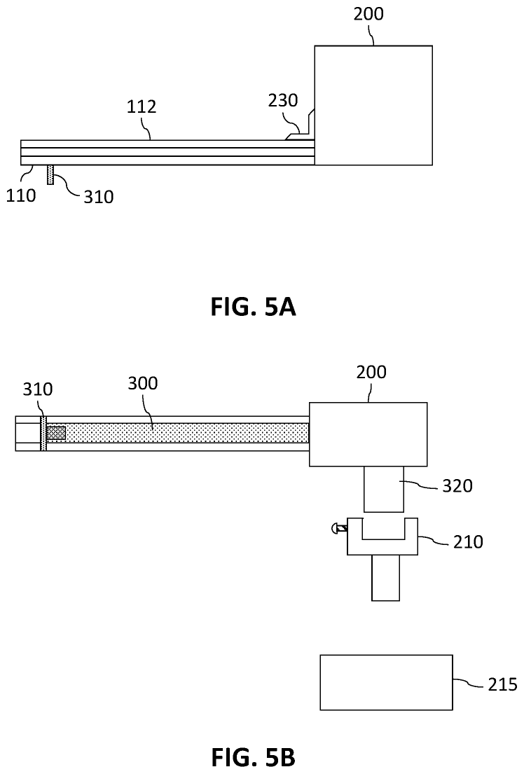

Referring now to FIG. 1, a box diagram representatively illustrates example components of a saw stop system (system) 100. A slide (not numbered) includes one or more trackways 110 and a sliding member (slider) 300 that is aligned to and captured by the trackway 110 using housing (chassis) 200. Slider 300 in implementations is bendable. FIG. 2A shows the slider transversely curved. This optional transverse curve stabilizes the transverse force component within the trackway 110 to help prevent issues such as bunching or binding, and allows slider 300 to self-support better when outside of trackway 110. FIG. 2B shows a schematic example of a slider 300 that can slide back and forth within a single section of trackway 110. As can be seen in FIG. 2B, in implementations the sliding member has an extended portion (i.e., a linear and non-coiled portion) that has a curvature transverse to a longest length of the extended portion—this curvature helps to keep the extended portion from bending and from otherwise moving or deforming, other than the movement of sliding back and forth within the trackway. It is also seen that the trackway at least partially encases or surrounds two edges of the extended portion—this also prevents or hinders bending of the sliding member within the trackway, and further otherwise prevents or hinders the extended portion from moving or deforming in any direction within the trackway other than sliding along the sliding direction. FIG. 2C shows a face of the slider exposed through the aperture, with numbering and measurement/tick marks visible. FIG. 2D shows trackway 110 coupled with a trackway support (support) 112 to provide additional structural support and to provide a way to attach other accessories. This coupling can be accomplished, by non-limiting example, by a standard threaded screw or bolt (such as the screw shown in FIG. 2D) threaded onto a standard nut. The nut is not shown in FIG. 2D, but a standard nut as is known in the art, sized to fit within the larger portion of the T-slot (but sized too large to fit within the smaller portion of the T-slot) of support 112, for example, would achieve the desired functionality. The head of the screw or bolt could be configured such that it is flush with the inner face of trackway 110 or so that it otherwise does not interfere with sliding movement of slider 300 within trackway 110. The relative dimensions of the elements in FIGS. 2A-2D are only examples. The trackway and trackway support can be merged into a single part in some implementations. The trackway in implementations could have a length greater than its height and, correspondingly or similarly, the Support 112 could have a length greater than its height, as per FIGS. 3 and 5A for example. FIG. 3 shows a schematic example where slider 300 can slide back and forth within multiple independent sections of trackway 110 in a non-linear fashion. One embodiment of the saw stop system utilizes a modified tape measure as the slider 300. In implementations, however, the slider 300 may not have all (or may not have any) characteristics of a tape measure.

FIG. 1 shows processor 500. Processor 500 provides a way to control elements of the saw stop system 100, including retrieving, storing, and processing data coming from elements of the system. Processor 500 uses memory 510, and data communicator (communicator) 520 which may, by way of example, be an integrated circuit (IC) or semiconductor chip. In implementations communicator 520 includes both WiFi and BLUETOOTH capabilities. Capabilities of processor 500 can be extended by data communicator 520 and remote processor 550. Remote processor 550 can be extended/multiplied indefinitely. In implementations processors of mobile computing devices (cellphones, tablets, etc.), and/or processors of remote servers communicatively coupled with the mobile computing devices, comprise remote processor(s) 550.

FIG. 1 shows an aperture 120 that can be optionally included as part of trackway 110. The purpose of aperture is to provide a view of the slider 300 such as for an optical sensor, or to provide a way for any other type of sensor to access the slider. FIG. 2C shows aperture 120 within trackway 110. The trackway reveals the slider through the aperture and also facilitates sliding of the slider within the trackway.

FIG. 1 shows light adapter 130 and light source 140. The light adapter adapts light from the light source such as by channeling, guiding, diffusing, etc. the light toward/to aperture 120 such that slider is illuminated for optical imaging. The light adapter could include, by non-limiting examples, one or more light pipes, a light diffusion device, etc. In implementations the light adapter includes a diffuser and gray colored walls and is positioned to get even lighting on the tape measure.

As indicated, FIG. 1 shows light source 140. The light source includes one or more sources of light, adapted or modified or directed (or the like) by light adapter 130, to illuminate the slider through the aperture. The light source and/or light adapter may in implementations be controlled by processor 500.

FIG. 1 shows camera 160. In implementations the camera is (or includes) a visual sensor which reads or determines an absolute or relative position of slider 300 within trackway 110. By non-limiting example, the camera may sense/read, and/or capture an image of, one or more tick marks and numerals on the slider, so that the control module can identify an absolute position of the slider. The system may determine a distance from the saw blade to position the stop/tab, and may use a user-input cut length (such as input using a mobile device software app user interface, the mobile device in communication with the control module, or the like) and the sensed length indicators (tick marks and numbers on the slider) to automatically move the tab/stop to the determined distance. In implementations the determined distance may be at least partially determined by interpolation between two tick marks—for example the system/control module may determine that for the tab/stop to be at the determined distance, the slider should stop so that a positioner marker (not shown in the drawings) visible to the camera is positioned between two sensed tick marks at some interpolated position therebetween. An interpolated position could be any location between the two tick marks. In implementations camera 160 may be controlled by processor 500. Camera 160 may provide position data to processor 500, and processor 500 may decode or determine a position, such as using optical recognition algorithms or the like.

FIG. 1 shows saw stand coupler 210. In implementations a saw stand coupler provides a quick and easy way to attach and detach a saw stop system (or elements of a saw stop system) from a saw or a saw stand while assuring/maintaining relative positioning to a saw blade. The saw stand coupler 210 in implementations helps to prevent calibration and setup issues by assuring consistent relative position to the saw blade.

FIG. 1 shows tab (stop) 310. Tab/stop 310 is coupled with the slider and may be used to mechanically couple the slider with various items, similar or identical to the tab of a tape measure. In implementations the tab forms a 90-degree angle relative to a face of the slider and rests against a board or other item to be cut to ensure that it is in a proper position for sawing. FIG. 2B shows an example tab 310 connected to the slider 300. FIGS. 2A and 2B show that upper and lower portions of the trackway 110 are sized and positioned so as to not contact the tab in a way that would obstruct sliding of the slider.

FIG. 1 shows motor 320. The purpose of motor 320 is to provide a way to move the slider 300 within the trackway 110 (mechanically, electromechanically, etc.). Motor 320 may be controlled by processor 500 and/or may provide data to processor 500. In implementations motor 320 includes a stepper motor and stepper motor driver.

FIG. 1 shows brake 330. In implementations the brake 330 holds/maintains a position of the slider 300 relative to the trackway 110. The brake 330 could be a brake of any type (mechanical, electromechanical, etc.). In implementations the brake uses stepper motor torque, and/or a cam driven by a servo, to provide a braking force. In implementations the brake is controlled by processor 500.

FIGS. 1 and 3 show storage member 340. In implementations storage member 340 is used to store or house all or a part of slider 300 in a stored position in a small space. One embodiment of a saw stop system uses a tape measure for the slider 300. In such an implementation the tape measure may already include a spring used to re-coil the tape measure inside a housing. However, in implementations, because of the motor 320, the saw stop system would not require a spring to coil the tape inside a housing. In some implementations the saw stop system does not include storage member 340 and does not coil the slider into a smaller space in a stored configuration, but in implementations such elements are convenient. In implementations the storage member forces the slider into a coiled configuration by virtue of the walls or housing elements of the storage member and/or using an axle or spring or the like around which the slider coils. In implementations the storage member may include a spring and/or one or more axles but no separate housing, though the storage member may be at least partially housed within the housing/chassis 200.

FIGS. 1 and 3 show extender 350. In implementations the length of extender 350 defines an offset from tab 310. In implementations the tab 310 cannot be placed near the saw blade, due to interference from the saw's fence and the housing/chassis 200, and smaller pieces thus cannot be cut while using the tab. By offsetting the tab with a piece of wood (or other material) of known length and indicating to the processor 500 (such as by a signal from the extender or by other means) that an extender is being used, the system will position the tab accordingly so smaller pieces of material can be cut. This can include, for example, the system determining the appropriate distance between the tab/stop and the saw blade, prior to the cut, by adding a length of the extender to an input cut length received from the user (at a user interface or the like). The system could also do other calculations, in addition to or alternative to this summing operation, to determine the appropriate distance between the tab/stop and the saw blade for the cut.

FIG. 3 is a top see-through view of components of one embodiment of a saw stop system. The slider 300 is connected with tab 310 (and potentially extender 350). A portion of slider 300 is coiled and stored within (or at least partially within) storage member 340. Slider 300 is slidably coupled with, and slides within (or at least partially within), independent sections of linear trackway 110 and non-linear trackway 111 (which is similar or identical to trackway 110 except in that it has curvature as viewed from this top perspective and, accordingly, bends the portion of the sliding member that is at least partially within it). Slider 300 is moved forward and backward within trackway 110 via drive wheel 322 (which is rotated using motor 320, not shown in FIG. 3). A pinch wheel 324 abuts a face of the slider and presses an opposite face of the slider against the drive wheel so as to provide friction for the slider to be moved by the drive wheel. The motor, using torque, can cause the drive wheel 322 to itself act as a brake, and a secondary brake 330 is also implemented. Camera 160 is positioned by camera aligner 150 (potentially using commands from the processor) and detects the position of slider 300 through aperture 120 aided by light from the light source 140 as adapted by the light adapter 130. In implementations processor 500 controls, and/or processes data from, light source 140, camera 160, one or more optical sensors within or coupled with camera 160 or otherwise within or coupled with control module (controller) (module) 505, motor 320, and brake 330. The processor stores and processes data from memory 510 and extends processing capabilities via data communicator 520 and remote processor(s) 550. Data communicator 520 may be included within, or coupled with, module 505, though for ease of viewing other elements it is not shown in FIG. 3. Some elements of the saw stop system (though, as can be seen in FIG. 3, not necessarily all) may be housed within chassis 200.

In implementations a remote processor 550 (such as a processor of a mobile phone) runs software that initiates a connection with processor 500 through data communicator 520 (such as using a BLUETOOTH or WiFi connection). The mobile phone software may display a user interface that lets the user perform calibration, enter measurements and other measurement attributes, and perform other related functions. In implementations, other types of user interfaces may be used. As used herein, the term “user interface” may refer to any user input element, be it a visual touchscreen or visual screen and keyboard elements, a microphone to receive audio input and/or elements to perform speech recognition, a knob or dial for the user to rotate to one of a plurality of preset cut lengths (or to otherwise input/select any desired or custom cut length), and so forth. Notwithstanding this, in implementations the user interface is a visual touchscreen interface displayed on a mobile phone using a mobile app, the mobile phone communicatively coupled with the control module, or a visual touchscreen interface (and/or including physical buttons or other selectors) physically coupled with the chassis/housing 200.

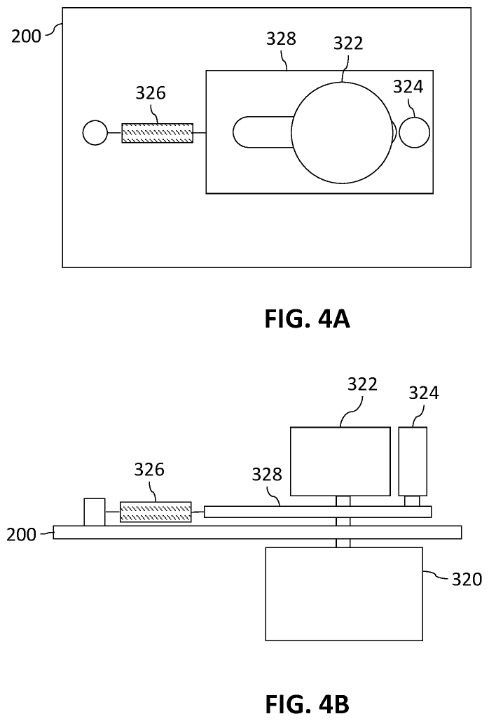

FIG. 4A is a top view, and FIG. 4B is a front view, showing an example mechanism for biasing the pinch wheel 324 and drive wheel 322 toward one another with a constant force. Other mechanisms could be deployed to move the slider. This example mechanism employs a spring 326 which is attached to a chassis 200 on one side, and to a pinch wheel slide 328 on the other side. The pinch wheel 324 is in a fixed position relative to the pinch wheel slide 328, being anchored thereto, though the pinch wheel may rotate relative to the pinch wheel slide. The pinch wheel slide 328 has a channel (and the chassis has a corresponding opening, not seen in the drawings) that allows an axle/shaft or arbor of the motor 320 to pass therethrough, which arbor rotates the drive wheel 322. Some elements of FIGS. 4A and 4B are not shown in FIG. 3, as FIG. 3 is a simplified view, whereas FIGS. 4A and 4B are more detailed views. In FIGS. 4A and 4B the spring 326 biases the pinch wheel slide, and therefore the pinch wheel, toward the left, so that the pinch wheel is biased toward the drive wheel. This bias allows the pinch wheel and drive wheel to hold the slider therebetween and move the slider by rotation of the drive wheel.

FIG. 5A is a top view, and FIG. 5B is a corresponding front view, of elements of a saw stop system. Chassis 200 may be coupled with trackway support (support) 112 using gusset 230 and trackway 110. Gusset 230 may be coupled via one or more standard screws and nuts using the T-slot on one face (similar to what is described above, in relation to FIG. 2D, for coupling trackway 110 to support 112), and the chassis 200 may be coupled with the opposite T-slot (or one of the other T-slots, as desired), in a similar manner (in implementations this may hold or position the slider 300 in alignment with trackway 110). Slider 300 slides through trackway 110, moving tab 310 to the right or the left. Motor 320 is attached to saw stand coupler 210. Saw stand coupler 210 is in turn attached to saw stand 215, which may, by non-limiting example, be a tripod or other saw stand (in FIG. 5B the saw stand is simply shown as a box diagram element, and not in the actual form of a saw stand, for simplicity, but saw stands are known in the art so do not need to be illustrated for the practitioner of ordinary skill in the art to make and use the disclosed inventions).

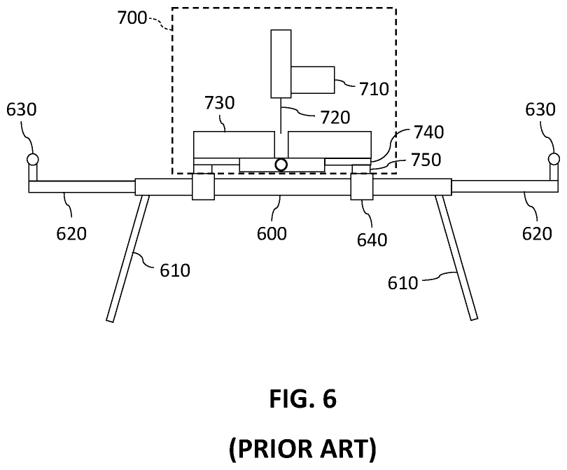

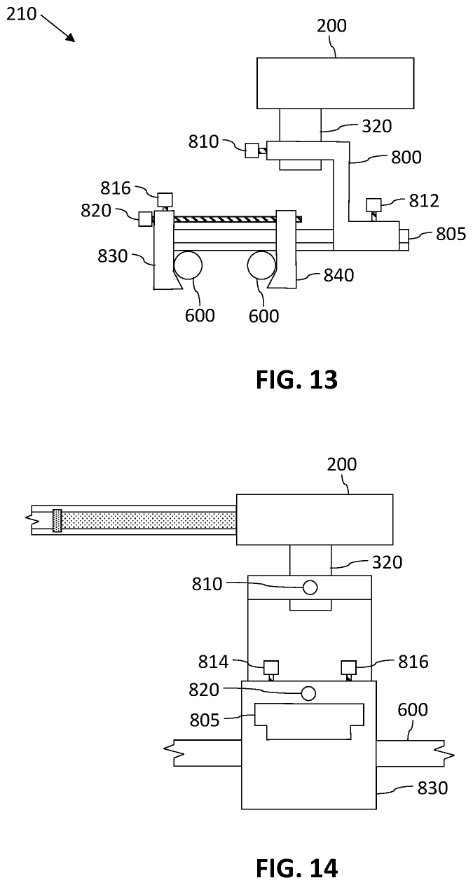

FIG. 6 shows a simplified drawing of a prior art miter saw 700 attached to a prior art saw stand 600. Saw stand 600 forms a platform using two parallel metal pipes (both pipes of saw stand 600 are visible in FIG. 13, for example, but from the perspective of FIG. 6 only one is visible). FIG. 6 gives context for how the saw stop system 100 may attach to and interact with a prior art miter saw 700 and prior art saw stand 600. Miter saw 700 includes motor 710, miter saw blade 720, miter saw fence 730, miter saw bed 740, and miter saw leg 750. Saw stand 600 includes saw stand legs 610, saw stand extension arms 620, and saw stand rollers 630.

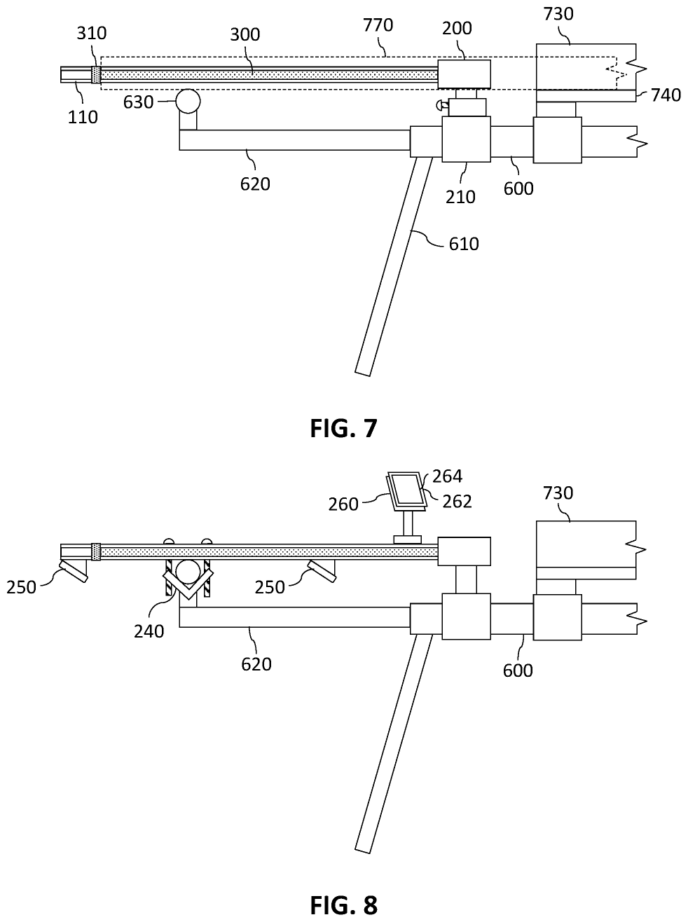

FIG. 7 shows elements of a saw stop system attached to saw stand 600, and the miter saw fence 730 of miter saw 700 is visible. Item to be cut (item) 770 (displayed in see-through format for ease of viewing other elements, and which in implementations may be a wooden board or any other item to be cut), is shown abutting tab 310 and resting on saw stand roller 630 and miter saw bed 740. In FIG. 8 trackway 110 and trackway support 112 (not visible) are attached to saw stand roller 630 via clamp 240. Guide 250 is attached to trackway support 112 providing a ramp for flexible boards to slide up as they are being moved down the board lane in the direction away from the miter saw blade. For example (and referring also to FIG. 12, which is a front, side, top view of some of the elements of FIG. 8 with additional example miter saw components shown), when a thin board (or other thin material) is to be cut the user can put it on the board lane 760 and it will rest on a platform of the saw and on the saw stand roller 630. But if the item to be cut it is relatively long, then beyond the saw stand roller 630 it will begin to droop down below the saw stop. Referring to FIG. 12, if the user is sliding a board from right to left along board lane 760, the guide 250 will help keep the board from drooping. Implementations of saw stop systems may include as many guides as are desired along the trackway support. In FIG. 12 the trackway support is not shown, but as the practitioner of ordinary skill in the art will understand, each guide may be sized and configured/shaped to be coupled with the trackway support, for example in a similar manner as that described above for coupling the trackway to the trackway support.

FIG. 12, as indicated above, shows board lane 760. Although a board is not shown, boards of varying sizes and configurations are known in the art (for example 2×4 boards, 4×4 boards, wood paneling or trim, etc., formed of wood or other materials). Accordingly, the boards themselves do not need to be shown for the practitioner of ordinary skill in the art to know how to make and use the disclosed inventions. In implementations the system first automatically positions the tab at an appropriate position to achieve the desired cut length. For example the user, using a mobile app on a device communicatively coupled with controller 505, may input the desired cut length, and in response the system may automatically move the tab to the appropriate position for achieving that cut length. A board or other item to be cut (for example a wooden board, a pipe formed of polymer or a metal, or any other item) may then be positioned within board lane 760 and a terminal end of the board or other item may be placed abutting tab 310. The board or other item may then be cut, and the length of the cut board or other item will be the length that was input by the user.

Referring back to FIG. 3, in comparison with FIG. 12, it may be understood that an extender 350 may be coupled directly with the tab, instead of the board or other item to be cut, and the board or other item to be cut may then abut the extender instead of abutting the tab directly. This is useful because in implementations the tab 310 can only come within a certain distance from the saw blade, due to interference from the saw's fence and the chassis, and some smaller pieces to be cut are short enough that they cannot contact the tab. By offsetting the tab with an extender (which, in implementations, may simply be a piece of wood of known length) and indicating to the processor 500 that an extender is being used (such as by a proximity signal using a sensor or other item coupled the extender, or by input from the user into an input field on a mobile app user interface or the like, or by other means), the system will position the tab accordingly, taking account the offset length due to the extender, so that the smaller piece of material can be cut.

Podium 260 is attached to trackway support 112 to provide a means to mount a device (such as a phone or an electronic device) or notes or some other item for viewing while cutting. As indicated above, a mobile device such as a phone may be used which may be communicatively coupled with the controller (such as through BLUETOOTH or WiFi), and user interfaces of an app installed on the mobile device may allow the user to input the desired cut length and perform other actions.

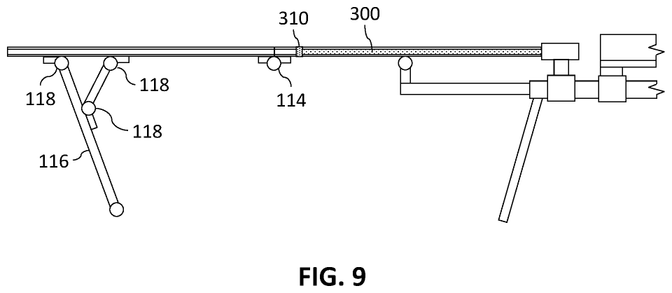

FIG. 9 shows two trackways 110 abutted using hinge 114. A folding leg 116 is also implemented via three folding leg hinges 118, two of which are attached to trackway support 112.

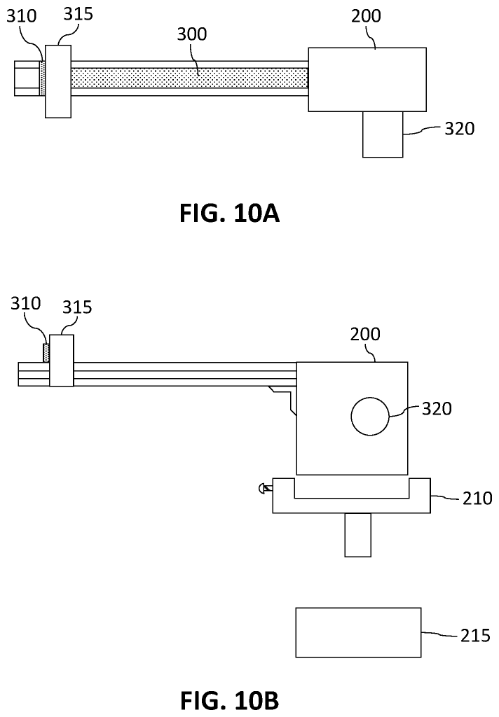

FIG. 10A is a top view, and FIG. 10B is a front view, showing another orientation for the saw stop system (relative to the orientations shown in FIGS. 5A and 5B). In this case, a carriage 315 is attached to tab 310. This forms a stop to either side of the tab 310 and is useful in instances where a carriage/stop bigger than the tab 310 is desired.

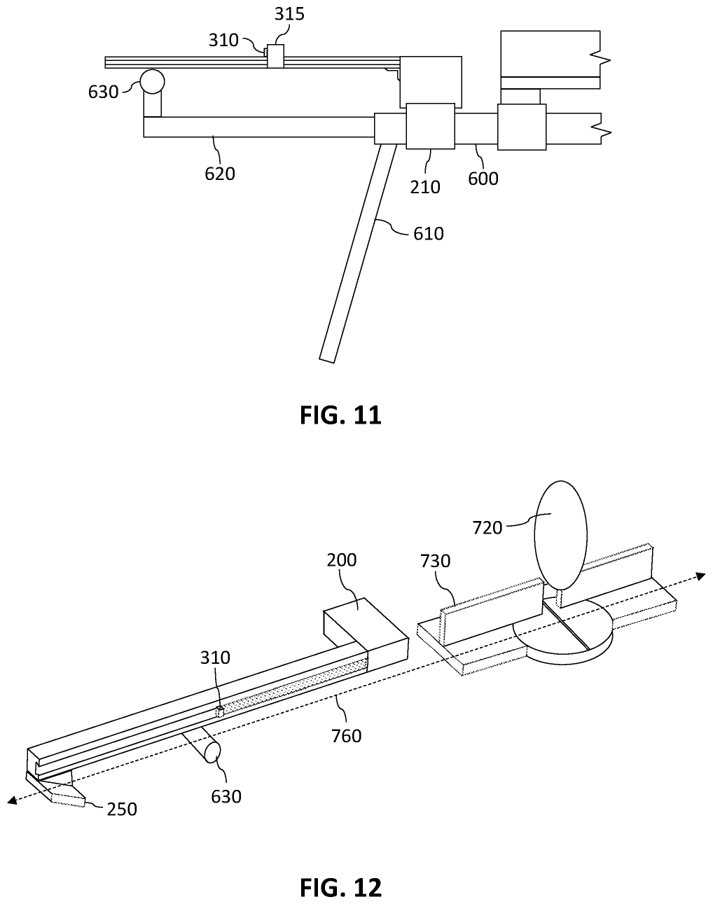

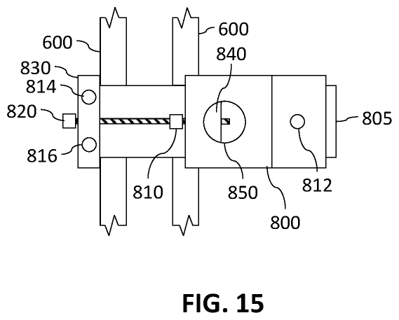

FIG. 11 shows a front view of a saw stop system, as oriented in the top views of FIGS. 10A-10B, coupled with saw stand 600 via saw stand coupler 210. Saw stand coupler 210 can be any mechanism used to attach the saw stop system to a saw stand. FIGS. 13-15 show different views of a saw stand coupler and related elements. FIG. 13 is a side view, FIG. 14 is a front view, both of which show the chassis 200 and motor 320, and FIG. 15 is a top view excluding the chassis and motor. These figures show an example saw stand coupler that adjusts along X, Y, and Z axes (each axis orthogonal to the other two). Chassis 200 is connected to motor 320. Motor 320 slips through a motor hole 850 in stand 800. At an appropriate height along the Z-axis, thumb screw A 810 on the stand 800 can be tightened against motor 320 to fix its height. Stand 800 slides along track 805 along the Y-axis. Thumb screw B 812 is tightened to fix the stand against track 805 along the Y-axis. Clamp arm A 830 and Clamp arm B 840 form the jaws of a clamp. Long thumb screw 820 is turned to cause the clamp arms to put pressure against saw stand 600 (two parallel metal tubes) to fix the stand along the X-axis. Thumb screw C 814 and thumb screw D 816 fix clamp arm A 830 to track 805 so only clamp arm B 840 moves when long thumb screw 820 is turned.

In implementations the user initiates sending measurement information to the processor 500 over BLUETOOTH or WiFi to cause processor 500 to cause motor 320 to move slider 300 in such a way to place the tab 310 at the correct position within a certain allowed measurement error.

When the processor 500 receives the measurement, it will: take a picture with camera 160 and use processor 500, memory 510, and/or remote processor 550 to process algorithms that determine the absolute position of the slider; add a calibrated offset to the absolute position; calculate a number of steps to move the motor to the needed location; engage the motor to move the slider as calculated; repeat the above four steps until the slider is in the desired position; hold position with torque of the motor and/or with the brake; send a message back to a mobile phone app that the system is ready for the cut; and display a signal on a user interface of the phone app indicating that the user can cut.

Other embodiments may use an electronic tape measure (or similar capability) instead of the optical system described above.

In implementations the saw stop system may function as a digitally-controlled linear slide for any other applications (e.g., any applications other than sawing) in which an inexpensive linear slide is useful. In such cases the elements of the saw stop system could simply be called a measurement system, and could be used to provide any desirable measurement.

In implementations a saw stop system may be used in conjunction with any saw type in addition to (or alternative to) any saw types shown in the drawings, such as for moving a table saw fence, a circular saw fence, a drill-press fence, a jig-saw fence, etc., or moving any item to be cut in relation to such saws or saw fences.

In implementations processor 500 or a remote processor may include or may interface with or utilize voice/speech recognition software/capability to allow a user to vocally provide or enter measurements.

In implementations a saw stop system may include software for performing automated or semi-automated kerfing and/or may include functionality to allow a user to provide or generate custom software or modify software or provide inputs to software for custom automated or semi-automated kerfing.

Although the trackway 110 and support 112 are shown as separate components, in implementations they could be a single component, such as a single extruded aluminum component. Any other group of components that do not need to move relative to one another could similarly be integrally formed as a single component through any manufacturing technique such as extrusion, milling, stamping, three-dimensional (3D) printing, and so forth, and may be formed of metals, ceramics, polymers, composites, and so forth.

In implementations, saw stop systems disclosed herein collect and record information about measurements. While prior art saw stops and gauge systems exist, there exists a need for saw stop and measurement systems and related methods with the features and advantages disclosed herein. Some comparisons with specific prior art saw-related systems are given below.

The apparatus of U.S. Pat. No. 8,783,140 has a rail module, but the saw stop systems disclosed herein do not require a single rail, and can accommodate multiple abutting, non-adjacent, or even non-linear trackways. Any number of extensions can be made or added to the trackways. Equipment such as bearings, screws, wheels, chains, belts, etc., are not needed to extend the trackways of the disclosed saw stop systems. The ability to break down the trackways into segments, and the lower weight due to fewer components, is an advantage for portability and shipping.

U.S. Pat. No. 8,783,140 has a rail module including a fence and a movably connected stop. One disadvantage of this technology is that the measurement distance is limited by the length of the rail. The disclosed saw stop system sliders and stops (tabs) extend past the trackway providing a huge advantage of extended length without commensurate need for a matching fence and rail. The saw stop systems disclosed herein instead extend a slider down a trackway. Therefore, they do not require the cost or complexity of belts, chains, screws or any of the associated equipment such as bearings, wheels, etc. that may be necessary for such a rail module apparatus to move the stop.

U.S. Pat. No. 8,783,140 has a motor and controller that is interchangeably mountable, adjacent each opposite end of a fence, to drive a stop. The saw stop systems disclosed herein do not require adjacency of the motor at the ends. Since the saw stop system sliders disclosed herein are bendable, they can be directed around corners using non-linear or curved trackways and related elements. For example, for the disclosed saw stop systems it is possible to have the motor in the center of a trackway, or somewhere else non-adjacent to the trackway, providing for flexibility in motor mounting options.

The apparatus of U.S. Pat. No. 5,875,987 motorizes a tape measure, but the motor is not controlled to position to a certain measurement based on user input, and the apparatus does not use linear or non-linear tracks to position the tab to a desired position.

In general, prior art saw stop technologies typically use a stop that moves along a linear rail and is moved by a belt, chain, or screw attached to a motor. Adding extensions to the rail is an issue for wheels or bearings traversing the intersection points and so systems are limited to a single rail to avoid the intersection issue. Extension alignment and intersection mismatch are a problem for prior art systems. Adding extensions or a longer single rail also requires extending the belt, chain, or screw and associated hardware, etc. Accuracy of belts and chains can become a difficult issue to solve. For example, it becomes more challenging to keep belts tight over longer distances. Length often requires additional hardware to keep dimensional accuracy.

Additionally, saw stop systems disclosed herein use a motor to push a slider around a 90-degree corner (or a bend of another angle). This bend provides the ability to place the motor and drive wheels in a location where they will not interfere with the board lane—the place where boards sit during a cutting operation.

One or more prior art systems appear to use a relative placement system that requires repeated zeroing. The disclosed saw stop systems, however, use a camera to read the slider location and detect/determine absolute measurements without needing repeated zeroing. Once the saw stop system is setup relative to the saw and calibrated once, calibration or zeroing may not be required to start future sessions. This is an advantage over other systems.

The REEKON M1 roller measure (disclosed together with this application in conjunction with an information disclosure statement) attaches to a saw and provides a way to measure a board linearly—the user slides the board under the roller until reaching the proper measurement. The saw stop systems disclosed herein have the possibility to perform a similar function. For example, the motor can be idled and then the user can push a board down the board lane in a similar fashion—but instead of causing a roller to spin, the board would push against the stop (with or without the extender). The motor could provide minimal back pressure that can be overcome by the user pushing the board back and forth while having the stop move with the board. The optical system (or control module and camera) could measure the distance periodically and display it on a user interface, thus providing a feedback mechanism so the user knows when the board is in the correct position.

There are examples of software being used on a microcontroller to read a meter such as with ESP-32-CAM SMART WATERMETER (disclosed together with this application in conjunction with an information disclosure statement). With the saw stop systems disclosed herein, however, due to the ability to control the lighting of (and positioning of) the slider, the saw stop systems can use simple template matching algorithms to detect tick marks and numbers. With tick mark position and number detection, the software identifies the absolute position of the slider with respect to the chassis.

The saw stop systems disclosed herein are much easier to assemble and manufacture than prior art saw-related systems. In implementations this is due to much fewer physical parts and components being designed with manufacturability features (such as the chassis, trackways, electronics holders, wheel holders, etc.).

Linear sliding elements, generally, are used in a variety of technology areas, but the slides and related elements of the disclosed saw stop systems include novel, non-obvious methods, mechanisms, and uses of/for linear sliding elements.

The disclosed saw stop system are much more than a tape measure driven down a trackway driven by a motor controlled by smart software. Rather the disclosed saw stop systems are effective, low-cost, capable systems for producing accurate saw cuts at desired lengths. The saw stop systems can be used in many applications where an inexpensive linear slide would be useful. Attachments can be coupled with the stop/tab as desired within any particular system, such as to increase the size of the stop/tab.

Other advantages of the disclosed saw stop systems include: few components (hardware or otherwise) (for example no leadscrew, no bearing blocks, no belts, no rack-and-pinion, etc.); short trackways that are portable and can be joined together; various rail (or trackway) lengths, as desired, as the trackway length can be relatively independent of other elements; low weight (due to few components or otherwise); low cost (due to few components, little material, or otherwise); low complexity (due to few components or otherwise); potential for great reliability (due to few components or otherwise); easy assembly (due to few components or otherwise); great portability overall (due to light weight, ability to break down trackway segments, or otherwise); ability to combine trackway segments for any desired trackway length; slider ability to extend beyond a trackway segment (so that the stop is positioned beyond a terminal end of one of the trackways, in a direction away from the saw—whether the said trackway is the trackway furthest from the saw or is an intermediary trackway); little material required in/for a trackway; slider ability to bridge (extend between) non-adjacent trackway segments without additional components; great transportability; non-linear trackways and the ability to move the slider within the non-linear trackways; various options for motor placement; and so forth.

As described previously with respect to FIG. 3, some saw stop systems may include one or more trackways, with some of the trackways being linear (such as the two shown trackways 110) and some being curved (such as the shown trackway 111). This is one way in which a portion of the one or more trackways (i.e., the linear portions) prevent bending of the sliding member therein, while another portion of the one or more trackways (i.e., the curved portion) bends the sliding member therein. In some implementations a trackway could include both linear and curved portions, so that such trackway both prevents bending of a portion of the sliding member (within the linear portion) and bends a portion of the sliding member (within the curved portion). The curved trackway also, in implementations, prevents or hinders movement of the slider therein in any direction except the bending and motion along the curved sliding direction.

In implementations in which this disclosure discusses that the determined distance (e.g., a distance from the saw blade at which to position the stop/tab) corresponds with a length received from the user at or through a user interface, this can in implementations mean that the determined distance is the received length, or that the determined distance is calculated using the received length (for example the received length plus an extender length).

In implementations in which this disclosure discusses using the disclosed systems for measurement operations other than for sawing or cutting purposes, the determined distance may accordingly be a distance between an end of a first item and a second item instead of a distance between the end of the first item (or the tab/stop) and the saw blade. For example, the first item could be a wooden board and the second item could be a drill bit of a drill press, and the system could be used to properly position a board for a drilling operation, or the first item could be two overlapping sheets of metal temporarily joined (such as with vice grips or an adhesive or other mechanism) and the second item could be an automatic welder, such that the system is used to position two metal sheets to weld them at a desired location. Other uses are possible, and those given here are just representative examples.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of saw stop and measurement systems and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

As used herein, the term “of” may refer to “coupled with.” For example, in some cases displays are referred to as a display “of” a first computer or computing device, a display “of” a second computer or computing device, and so forth. These terms are meant to be interpreted broadly so that a display “of” a computing device may be a separate display that is, either by wired or a wireless connection, communicatively coupled with the computing device.

The phrase “computing device” as used herein is meant to include any type of device having one or more processors and capable of communicating information using one or more integrated or communicatively-coupled displays, such as a personal computer, a laptop, a tablet, a mobile phone, a smart phone, a personal data assistant (PDA), smart glasses, a tablet, a smart watch, a smart speaker, a robot, any other human interaction device, and so forth.

It is pointed out that the provider of a software application, to be installed on end user computing devices (such as, by non-limiting example, mobile devices) at least partially facilitates an at least intermittent communicative coupling between one or more servers (which host or otherwise facilitate features of the software application) and the end user computing devices. This is so even if the one or more servers are owned and/or operated by a party other than the provider of the software application.

Method steps disclosed anywhere herein, including in the claims, may be performed in any feasible/possible order. Recitation of method steps in any given order in the claims or elsewhere does not imply that the steps must be performed in that order—such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A saw stop system, comprising:
a first housing configured to be coupled with a saw;
a control module coupled with the first housing and comprising a processor, the control module configured to communicatively couple with a computing device having at least one user interface;
one or more trackways coupled with the first housing;
a sliding member slidably coupled at least partially within the one or more trackways, wherein a first portion of the one or more trackways prevents bending of the sliding member within the first portion;
a stop coupled with the sliding member and configured to couple with an end of an item to be cut to facilitate positioning of the end of the item, relative to a cutting element of the saw, at a determined distance corresponding with a length received through the at least one user interface; and
a motor coupled with the sliding member and controlled by the control module, the motor configured to automatically position the sliding member so that the stop is at the determined distance.

2. The saw stop system of claim 1, further comprising a storage member coupled with the first housing and configured to force a stored portion of the sliding member into a coiled configuration.

3. The saw stop system of claim 2, wherein the storage member comprises a second housing at least partially housed within the first housing.

4. The saw stop system of claim 1, wherein an extended portion of the sliding member comprises a curvature transverse to a longest length of the extended portion.

5. The saw stop system of claim 4, wherein the one or more trackways at least partially encases two edges of the extended portion of the sliding member.

6. The saw stop system of claim 1, further comprising an extender configured to couple between the item and the stop, and wherein the determined distance comprises the received length added to a length of the extender.

7. The saw stop system of claim 1, wherein a second portion of the one or more trackways bends the sliding member within the second portion.

8. The saw stop system of claim 1, wherein the one or more trackways comprise multiple trackways coupled together.

9. The saw stop system of claim 1, further comprising a drive wheel coupled with the motor and configured to rotate in response to a rotation of the motor, the drive wheel contacting a first face of the sliding member, and a pinch wheel contacting a second face of the sliding member, wherein the drive wheel and the pinch wheel are biased toward one another.

10. The saw stop system of claim 1, wherein the sliding member comprises one or more length indicators, wherein the control module comprises one or more visual sensors configured to sense the one or more length indicators, and wherein the control module controls the motor to position the stop at the determined distance using the sensed one or more length indicators.

11. The saw stop system of claim 10, wherein the one or more length indicators include tick marks and numbers, and wherein the control module controls the motor to position the stop at the determined distance using the tick marks and the numbers.

12. The saw stop system of claim 11, wherein the control module further controls the motor to position the stop at the determined distance using a determined position interpolated between two of the tick marks.

13. The saw stop system of claim 1, wherein the sliding member is configured to slide beyond a terminal end of one of the one or more trackways such that the stop is positioned beyond, and not partially within, the trackway.

14. The saw stop system of claim 1, further comprising a guide coupled with the one or more trackways, the guide configured to support the item to prevent drooping of the item.

15. The saw stop system of claim 1, further comprising a stand coupling the first housing with the saw, the stand configured to allow adjustment of the housing to multiple fixed positions relative to the saw along three axes, each of the axes orthogonal to the other two axes.

16. A method of use of a saw stop system, comprising:
coupling a first housing of a saw stop system with a saw, wherein the saw stop system comprises:
a control module coupled with the first housing and including a processor, the control module configured to communicatively couple with a computing device having at least one user interface;
one or more trackways coupled with the first housing;
a sliding member slidably coupled at least partially within the one or more trackways, wherein a first portion of the one or more trackways prevents bending of the sliding member within the first portion;
a stop coupled with the sliding member; and
a motor coupled with the sliding member and controlled by the control module;
using the motor, automatically positioning the sliding member so that the stop is at a determined distance relative to a cutting element of the saw, wherein the determined distance corresponds with a length received through the at least one user interface; and
coupling, to the stop, an end of an item to be cut.

17. The method of claim 16, wherein a second portion of the one or more trackways bends the sliding member within the second portion.

18. A measurement system, comprising:
a first housing;
a control module coupled with the first housing and comprising a processor, the control module configured to communicatively couple with a computing device having at least one user interface;
one or more trackways coupled with the first housing;
a sliding member slidably coupled at least partially within the one or more trackways, wherein a first portion of the one or more trackways prevents bending of the sliding member within the first portion;
a stop coupled with the sliding member and configured to couple with an end of a first item to facilitate positioning of an end of the first item, relative to a second item, at a determined distance corresponding with a length received through the at least one user interface; and
a motor coupled with the sliding member and controlled by the control module, the motor configured to automatically position the sliding member so that the stop is at the determined distance.

19. The measurement system of claim 18, further comprising a storage member coupled with the first housing and configured to force a stored portion of the sliding member into a coiled configuration.

20. The measurement system of claim 18, wherein a second portion of the one or more trackways bends the sliding member within the second portion.
